(19) United States
(12) Patent Application Publication
(10) Pub. No.: US 2012/0216727 A1
(43) Pub. Date: Aug. 30, 2012

(54) Portable Fireproof Safe Box

(76) Inventor: Huang Liangguo, Shanghai (CN)

(21) Appl. No.: 13/158,906

(22) Filed: Jun. 13, 2011

Related U.S. Application Data
(63) Continuation-in-part of application No. 29/386,219, filed on Feb. 25, 2011.

(51) Int. Cl. E05G 1/04

(52) U.S. Cl. 109/61; 109/62

(57) ABSTRACT

An attractive, light, portable, stand-up box that is scratch resistant, fireproof and water-tight. It adapts plastic material for casing combined with a metallic hinge. It includes a coded lock that is complemented by a deadlock position for additional safety. Its surface has a sawtooth structure that acts as a rib for strength and resists scratching as well as providing an esthetic look. An extra bar or other feature can keep the lid leveled at around 110 degrees when open, while two extra large feet enable the box to stand vertically open or closed. A waterproof seal resides in a groove around the lid to prevent water penetration (for example in a fire). An alkaline cement with embedded air bubbles injected into the walls provides fireproofing without adding too much weight.

### BACKGROUND

This is a continuation-in-part of U.S. Design patent application Ser. No. 29/386,219 filed Feb. 25, 2011. Application Ser. No. 29/386,219 is hereby incorporated by reference.

### FIELD OF THE INVENTION

The present invention relates to storage containers for valuable documents and the like and more particularly to a portable fireproof safe box.

### DESCRIPTION OF THE PRIOR ART

There are numerous boxes and containers known in the art for storing valuables and documents. In particular, there are fireproof boxes. Most such fireproof boxes are subject to scratching, are inconvenient to store, and do not contain very good locks, or they are very heavy. It would be advantageous to have a portable fireproof safe box that looked attractive, was resistant to scratching and was fireproof and was watertight. There are also fireproof safes; however, these are very heavy and cumbersome.

For example, U.S. patent application No. 2002/0056713 teaches a fire resistant container which is not a box, but more of an envelope.

U.S. Pat. No. 1,564,205 teaches a fireproof box, as well as U.S. Pat No. 1,038,428 which also teaches a fireproof box. Both of these devices are not attractive and are not very portable.

It would be extremely advantageous to have a light-weight, yet very strong, attractive box that could be used for any carrying or storage purpose, that was fireproof and water-tight with a coded or otherwise secure lock and stand-up feet so that it could be positioned upright as well as flat.

### SUMMARY OF THE INVENTION

The present invention relates to an attractive, light, portable, stand-up box that is scratch resistant, fireproof and water-tight. It adapts plastic material for casing combined with a metallic hinge. It includes a coded lock that is complemented by a deadlock position for additional safety. Its surface has a sawtooth structure that acts as a rib for strength and resists scratching as well as providing an esthetic look. An extra bar or other feature can keep the lid leveled at around 110 degrees when open, while two extra large feet enable the box to stand vertically open or closed. A waterproof seal resides in a groove around the lid to prevent water penetration (for example in a fire). An alkaline cement with embedded air bubbles injected into the walls provides fireproofing without adding too much weight.

### DESCRIPTION OF THE FIGURES

Attention is now drawn to several drawings that illustrate features of the present invention:

FIG. 1 shows a front perspective view of an embodiment of the present invention.

FIG. 2 shows a back perspective view of the embodiment of FIG. 1.

FIG. 3 shows a top view of an embodiment of the present invention.

FIG. 4 shows a bottom view of the embodiment of FIG. 3

FIG. 5 shows a front view of the embodiment of FIG. 3

FIG. 6 shows a back view of the embodiment of FIG. 3

FIG. 7 shows a side view of the embodiment of FIG. 3

Several drawings and illustrations have been provided to aid in understanding the invention. The scope of the present invention is not limited by what is shown in the figures.

### DETAILED DESCRIPTION OF THE INVENTION

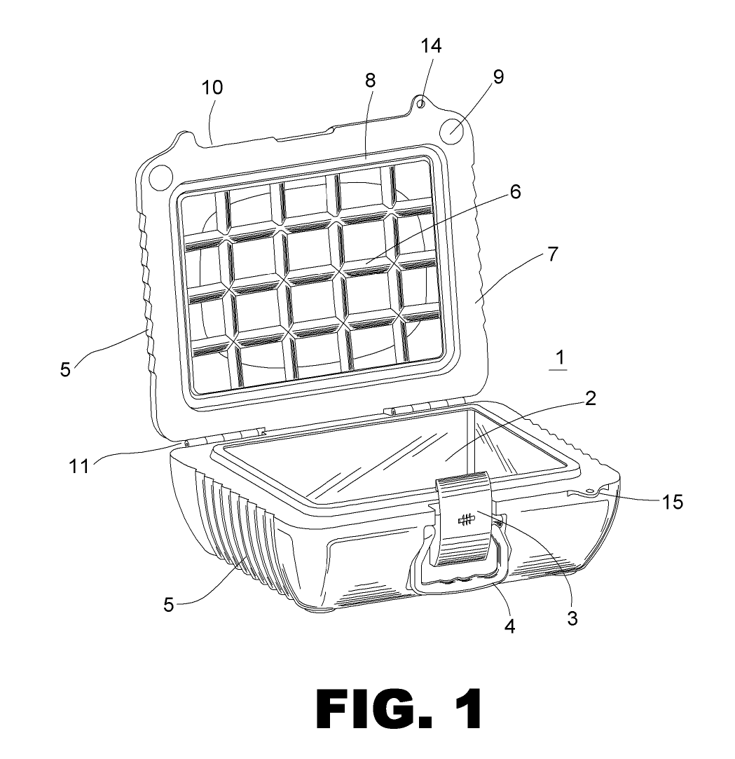

The present invention relates to a light, potable, scratch-resistant fireproof safe box. Turning to FIG. 1, a front perspective view of an embodiment of the invention is seen. A box base 1 contains a compartment 2 surrounded by fairly thick walls. The box base 1 has a handle 4 and a coded lever lock 3 with a deadbolt 15. The lever lock 3 can pull the lid tightly against the base 1 in a closed position to provide water-tightness through a rubber gasket or seal 8 that fits into a groove. This seal 8 can mate with a lip on the base unit. While the preferred material for most of the box is plastic, the coded lock 3 can be metal for strength. The outside of the box base can include sawtooth ribs 5 that give the structure a rough exterior which prevents sliding and provides additional strength and scratch-resistance. The sawtooth ribs 5 can be configured to totally circle the box longitudinally in a closed configuration. The handle 4 and coded lock 3 complement each other by being both attractive and secure.

A metallic axis hinge 11 on each side of the upper rim of the box base 1 attaches to a lid 10. This hinge 11 can be designed to give the fireproof cabinet a minimum space profile when closed while maximizing strength and reliability. The hinge 11 can be designed to have a metal bar that keeps the lid leveled at around 110 degrees when open. This feature prevents the lid from swinging fully out to 180 degrees or further. The lid has a pair of fill holes 9 and the rubber water seal gasket 8 embedded in a groove so that it fits snuggly around the rim to give a waterproof seal. This is particularly useful in case of a fire to prevent the entry of water. A flat area 7 outside the gasket mates neatly to an opposing flat area on the base to make a pleasantly appearing closure. The top 10 can have a set of internal ribs 6 for strength and esthetics. A deadbolt can optionally pass through holes 14, 15 to give the box extra security.

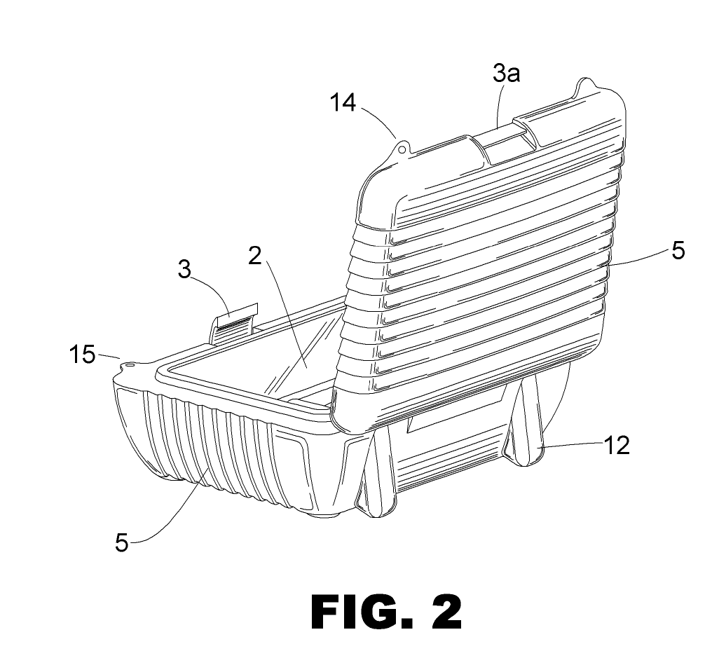

FIG. 2 is a back prospective view of the embodiment of FIG. 1. Here many of the features can be seen. In particular the ribs 5 and the two parts to the main latch 3 and 3a. A pair of stand-up legs 12 can be attached to the back flat side of the box base so that the device can easily stand upright as well as lie flat. The position of the lid 10 can be such that the cabinet will easily stand upright with the lid open as well as closed.

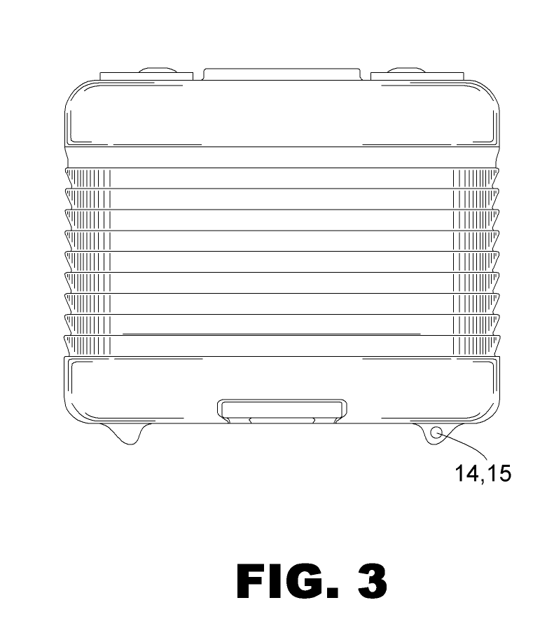

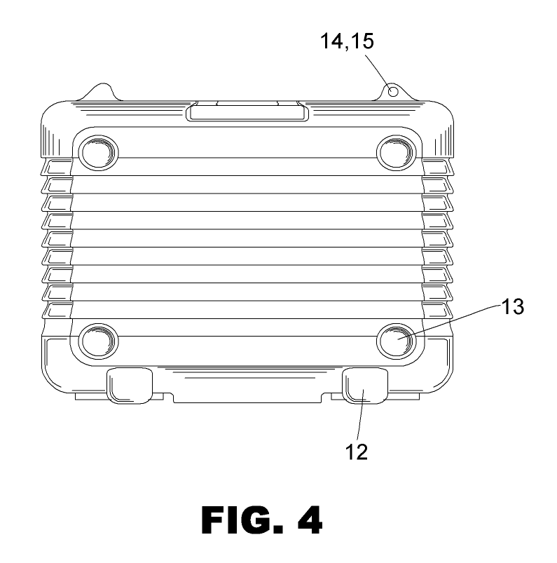

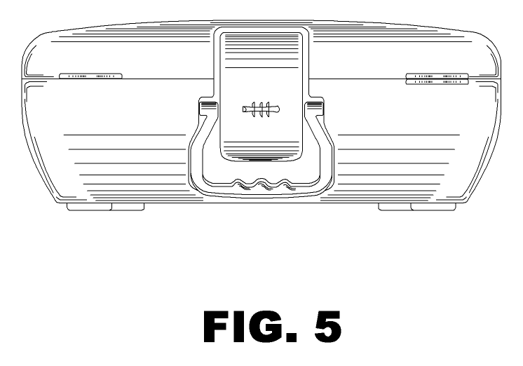

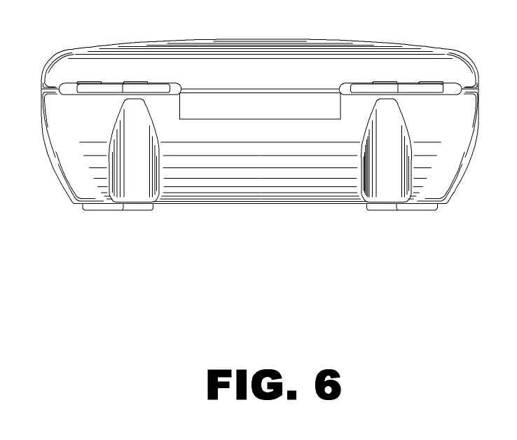

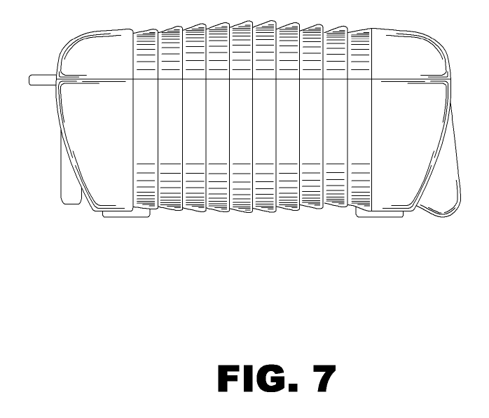

FIG. 3 shows a top view of an embodiment of the present invention. The ribs 5 can clearly be seen. FIG. 4 shows a bottom view of the embodiment of FIG. 3. Bottom feet 13 and stand-up legs (or back feet) 12 can be seen. FIG. 5 shows a front view of the embodiment of FIG. 3, while FIG. 6 shows a back view. FIG. 7 shows a side view of the embodiment of FIG. 3.

The lock shell 3 can hook a slot in the lid 10 to provide security from the lid unintentionally opening.

The bottom and top walls of the cabinet is filled with a light fireproof material. The preferred material is an alkaline cement permeated with air bubbles (for lightness) or otherwise containing embedded air bubbles. This material can be injected through injection holes 9 in the top and through holes under the feet 13 in the bottom.

Several descriptions and illustrations have been presented to aid in understanding the present invention. One of skill in the art will realize that numerous changes can be made without departing from the spirit of the invention. Each of these changes and variations is within the scope of the present invention.

We claim:

1. A portable fireproof safe box comprising:
a generally rectangular, smoothly contoured base unit with a generally rectangular storage compartment with an open top, said base unit having a lip around said open top;
a contoured, generally rectangular lid member attached to said contoured base unit along a portion of one edge with a pair of hinges, said lid member having a groove and rubber seal matching said lip and providing a water-tight closure when said lid is locked in a closed position;
a coded lock arm attached to an exterior surface of said base unit said lock arm adapted to engage a portion of said lid member in the closed position pulling said lid member tightly against said base unit;
a plurality of ribs on both said base unit and said lid member, said ribs providing structural strength and resistance to scratching;
a pair of support feet on a side surface of said base unit, said support feet permitting said safe box to stand upright with said side surface facing downward;
wherein, said hinge only allows said lid unit to open to an angle of around 110 degrees;
and wherein, said base unit and said lid member are filled with a an alkaline cement containing embedded air bubbles.

2. The portable fireproof safe box of claim 1 further comprising a deadbolt feature.

3. The portable fireproof safe box of claim 1 wherein said ribs run longitudinally across an outside surface of said lid member and a bottom surface of said base unit.

4. The portable fireproof safe box of claim 1 wherein said ribs run longitudinally around said safe box.

5. A generally rectangular fireproof box of the type used to store documents and other valuables comprising a bottom section with a storage chamber and a lid attached to said bottom section with a pair of hinges, said hinges adapted to prevent the lid from opening more than around 110 degrees, said lid and said bottom section containing a plurality of longitudinally running ribs wherein when the box is closed, said ribs circle said box, the ribs giving the box structural strength and scratch resistance; said bottom section and said lid coming together at a lip with a rubber seal that provides water-tightness, said lid and said bottom section being pulled tightly together with a coded lever lock, said lock also containing a deadbolt for additional security; said lid and said bottom section internally containing an alkaline cement with embedded air bubbles for fire resistance.

6. The fireproof box of claim 5 further comprising a pair of back feet on a rear surface of said bottom section, wherein said back feet allow said box to stand open or closed on said rear surface.

7. A portable fireproof safe box comprising:
a generally rectangular, smoothly contoured base unit with a generally rectangular storage compartment with an open top, said base unit having a lip around said open top;
a contoured, generally rectangular lid member attached to said contoured base unit along a portion of one edge with a pair of hinges, said lid member having a groove and rubber seal matching said lip and providing a water-tight closure when said lid is locked in a closed position;
a coded lock arm attached to an exterior surface of said base unit said lock arm adapted to engage a portion of said lid member in the closed position pulling said lid member tightly against said base unit;
a plurality of ribs on both said base unit and said lid member, said ribs providing structural strength and resistance to scratching;
a pair of support feet on a side surface of said base unit, said support feet permitting said safe box to stand upright with said side surface facing downward;
wherein, said hinge only allows said lid unit to open to an angle of around 110 degrees;
wherein, said base unit and said lid member are filled with a an alkaline cement containing embedded air bubbles;
and wherein said ribs run longitudinally around said safe box.

8. The portable fireproof safe box of claim 7 further comprising a pair of back feet on a rear surface of said bottom section, wherein said back feet allow said box to stand open or closed on said rear surface.

9. The portable fireproof safe box of claim 7 further comprising a deadbolt feature.

10. The portable fireproof safe box of claim 7 wherein said safe box is made of aluminum.
